(19) United States
(12) Patent Application Publication
(10) Pub. No.: US 2006/0224378 A1
(43) Pub. Date: Oct. 5, 2006

(54) Communication support apparatus and computer program product for supporting communication by performing translation between languages

(76) Inventors: Tetsuro Chino, Kanagawa (JP); Yuka Kuroda, Kanagawa (JP); Satoshi Kamatani, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/372,030

(22) Filed: Mar. 10, 2006

(30) Foreign Application Priority Data
Mar. 30, 2005 (JP) 2005-100032

(51) Int. Cl. G06F 17/28

(52) U.S. Cl. 704/2

(57) ABSTRACT

A communication support apparatus includes an analyzing unit that analyzes an source language sentence to be translated into a target language, and outputs at least one source language interpretation candidate which is a candidate for interpretation of the source language sentence; a detecting unit that, when there are a plurality of the source language interpretation candidates, detects an ambiguous part which is a different part between the respective candidates in the plurality of source language interpretation candidates; a translation unit that translates the source language interpretation candidate except the ambiguous part into the target language.

### CROSS-REFERENCE TO RELATED APPLICATIONS

This application is based upon and claims the benefit of priority from the prior Japanese Patent Application No. 2005-100032, filed on Mar. 30, 2005; the entire contents of which are incorporated herein by reference.

### BACKGROUND OF THE INVENTION

1. Field of the Invention

The present invention relates to a communication support apparatus, a communication support method, and a computer program product for supporting communication by performing translation between a plurality of languages.

2. Description of the Related Art

In recent years, with the development of natural language processing technology, a machine translation system that translates, for example, a text written in Japanese into a text in another language such as English has been put into practical use and been widely prevalent.

With the development of speech processing technology, there have been also utilized an speech dictation system in which the input of a natural language string by speech is enabled by converting sentences spoken by a user into letters, and an speech synthesis system that converts sentences obtained as electronic data and a natural language string output from a system into speech output.

With the development of image processing technology, there has been realized a character recognition system in which a sentence in an image is converted into machine-readable character data by analyzing a character image photographed by a camera or like. Moreover, with the development of handwritten-character technology, there has been realized a technique of converting a sentence input by a user through handwriting using a pen-based input device into a machine-readable character data.

With the globalization in culture and economy, chances of communication between persons who are native speakers of different languages have been increased. Consequently, there have been raised expectations for a technique applied to a communication support apparatus that supports communications between persons who are native speakers of different languages by integrating the natural language processing technology, speech processing technology, image processing technology, handwritten-character recognition technology.

As such a device, for example, the following communication support apparatus can be considered. First, a Japanese sentence spoken or input with a pen by a Japanese speaker is converted into machine-readable, Japanese character data, utilizing the speech recognition technology or handwritten-character recognition technology. Next, using the machine translation technology, the data is translated into a semantically equivalent English sentence and the result is presented as an English string. Alternatively, the result is presented to an English speaker in a form of English speech, utilizing the speech synthesis technology. On the other hand, an English sentence spoken or input with a pen by an English speaker is subjected to the adverse processing to thereby present a translated Japanese sentence to a Japanese speaker. By such a method, the realization of the communication support apparatus that enables two-way communication between persons who are native speakers of different languages has been attempted.

Furthermore, as another example, the following communication support apparatus can be considered. First, a string of a local sign, cautionary statement or the like, expressed in English is photographed with a camera. Next, the photographed string is converted into machine-readable, English string data utilizing the image processing technology and character recognition technology. Further, the data is translated into a semantically equivalent Japanese sentence, using the machine translation technology, and the result is presented to a user as a Japanese string. Alternatively, the result is presented to the user in a form of Japanese speech, utilizing the speech synthesis technology. By such a method, the realization of a communication support apparatus by which a traveler who is a native speaker of Japanese and does not understand English and who travels in an English-speaking area can understand the sign and cautionary statement expressed in English has been attempted.

In such a communication support apparatus, when the input sentence in an source language, which is input by the user, is recognized by the speech recognition processing, handwritten-character recognition processing or image character recognition processing to be converted into machine-readable character data, it is very difficult to obtain a proper candidate without fail, and generally, there arises ambiguity caused by obtaining a plurality of interpretation candidates.

In the machine translation processing, since there also arises ambiguity when an source language sentence is converted into a semantically equivalent target language sentence, a plurality of candidates for the target language sentence exist. Consequently, in many cases, the semantically equivalent object sentence cannot be uniquely selected and the ambiguity cannot be eliminated.

As its causes, for example, a case where the source language sentence itself is an ambiguous expression in which a plurality of interpretations exist, a case where a plurality of interpretations arise because the source language sentence itself is an expression having high context dependency, and a case where a plurality of translation candidates arise because linguistic and cultural backgrounds, a conceptual system and the like are different between the source language and the target language can be considered.

In order to eliminate such ambiguity, when a plurality of candidates are obtained, there are proposed a method of selecting a candidate obtained first and a method of presenting the plurality of candidates to a user so that the user makes a selection among them. Also, there is proposed a method in which, when a plurality of candidates are obtained, the respective candidates are scored according to some criterion to select a candidate with a high score. For example, in Japanese Patent Application Laid-Open (JP-A) No. H07-334506, there is proposed a technique in which a translated word in which the similarity of a concept recalled from the word is high is selected from a plurality of translated words resulting from the translation to thereby improve the quality of a translated sentence.

However, the method of selecting the candidate obtained first, in spite of having an effect of shortening processing time, has a problem in that there is no assurance of selecting an optimal candidate and that there is a high possibility that an target language sentence not matching the intention of the source language sentence is output.

The method in which the user makes a selection from a plurality of candidates has a problem in that the burden of the user is increased, and a problem in that when a number of interpretation candidates are obtained, they cannot be efficiently presented to the user. Moreover, there are a problem in that even if the user can properly select an interpretation candidate for the source language, ambiguity caused at the time of subsequent translation processing cannot be eliminated, and a problem in that even if in order to eliminate this, a translation processing result is also designed to be selected by the user, it is not an effective method because the user, normally, does not understand the target language.

In the method in JP-A No. H07-334506, since the user does not select the translated sentence candidate, but the translated sentence candidate is selected based on values calculated according to the criterion of the conceptual similarity, the burden of the user is reduced. However, there is a problem in that since it is difficult to set the criterion as a basis of scoring, there is no assurance of selecting optimal candidate and there is a possibility that an target language sentence not matching the intention of the source language sentence is selected.

### SUMMARY OF THE INVENTION

According to one aspect of the present invention, a communication support apparatus includes an analyzing unit that analyzes an source language sentence to be translated into a target language, and outputs at least one source language interpretation candidate which is a candidate for interpretation of the source language sentence; a detecting unit that, when there are a plurality of the source language interpretation candidates, detects an ambiguous part which is a different part between the respective candidates in the plurality of source language interpretation candidates; a translation unit that translates the source language interpretation candidate except the ambiguous part into the target language.

According to another aspect of the present invention, a communication support apparatus includes an analyzing unit that analyzes of a source language sentence to be translated into a target language, and outputs at least one source language interpretation candidate which is a candidate for interpretation of the source language sentence; a translation unit that translates the source language interpretation candidate into a target language, and outputs at least one target language interpretation candidate which is a candidate for the interpretation in the target language; a detecting unit that, when there are a plurality of the target language interpretation candidates, detects an ambiguous part which is a different part between the respective candidates in the plurality of target language interpretation candidates; and a generating unit that generates a target language sentence which is a sentence described in the target language, based on the target language interpretation candidate except the ambiguous part, and outputs at least one target language sentence candidate which is a candidate for the target language sentence.

According to still another aspect of the present invention, a communication support apparatus includes an analyzing unit that analyzes a source language sentence to be translated into a target language, and outputs at least one source language interpretation candidate which is a candidate for interpretation of the source language sentence; a translation unit that translates the source language interpretation candidate into a target language, and outputs at least one target language interpretation candidate which is a candidate for the interpretation in the target language; a generating unit that generates a target language sentence which is a sentence described in the target language, based on the target language interpretation candidate, and outputs at least one target language sentence candidate which is a candidate for the target language sentence; a detecting unit that, when there are a plurality of the target language sentence candidates, detects an ambiguous part which is a different part between the respective candidates in the plurality of target language sentence candidates; and a deleting unit that deletes the ambiguous part.

According to still another aspect of the present invention, a communication support apparatus includes an analyzing unit that analyzes a source language sentence to be translated into a target language, and outputs at least one source language interpretation candidate which is a candidate for interpretation of the source language sentence; a detecting unit that, when there are a plurality of the source language interpretation candidates, detects an ambiguous part which is a different part between the respective candidates in the plurality of source language interpretation candidates; a parallel translation pair storing unit that stores a parallel translation pair of the source language interpretation candidate and a target language sentence candidate semantically equivalent to each other; and a selecting unit that selects the target language sentence candidate, based on the source language interpretation candidate except the ambiguous part and the parallel translation pair stored in the parallel translation storing unit.

According to still another aspect of the present invention, a communication support method includes analyzing the a source language sentence to be translated into a target language; outputting at least one source language interpretation candidate which is a candidate for interpretation of the source language sentence; when there are a plurality of the source language interpretation candidates, detecting an ambiguous part which is a different part between the respective candidates in the plurality of source language interpretation candidates; translating the source language interpretation candidate except the ambiguous part into the target language.

According to still another aspect of the present invention, a communication support method includes analyzing the a source language sentence to be translated into a target language; outputting at least one source language interpretation candidate which is a candidate for interpretation of the source language sentence; translating the source language interpretation candidate into a target language; outputting at least one target language interpretation candidate which is a candidate for the interpretation in the target language; when there are a plurality of the target language interpretation candidates, detecting an ambiguous part which is a different part between the respective candidates in the plurality of target language interpretation candidates; generating a target language sentence which is a sentence described in the target language, based on the target language interpretation candidate except the ambiguous part; and outputting at least one target language sentence candidate which is a candidate for the target language sentence.

According to still another aspect of the present invention, a communication support method includes analyzing the a source language sentence to be translated into a target language; outputting at least one source language interpretation candidate which is a candidate for interpretation of the source language sentence; translating the source language interpretation candidate into a target language; outputting at least one target language interpretation candidate which is a candidate for the interpretation in the target language; generating a target language sentence which is a sentence described in the target language, based on the target language interpretation candidate; outputting at least one target language sentence candidate which is a candidate for the target language sentence; when there are a plurality of the target language sentence candidates, detecting an ambiguous part which is a different part between the respective candidates in the plurality of target language sentence candidates; and deleting the ambiguous part.

### BRIEF DESCRIPTION OF THE DRAWINGS

FIG. 1 is a block diagram showing a configuration of a communication support apparatus according to a first embodiment;

FIG. 2 is a flowchart showing the overall course of communication support processing in the first embodiment;

FIG. 3 is a flowchart showing the overall course of ambiguous part exclusion processing;

FIG. 4 shows an example of data processed in the communication support apparatus according to the first embodiment;

FIG. 5 shows examples of an source language sentence output by an source language speech recognizing unit;

FIGS. 6A to 6F show examples of source language interpretation candidates output by an source language analyzing unit;

FIGS. 7A to 7F show examples of target language interpretation candidates output by a translation unit;

FIG. 8 shows examples of target language sentence candidates output by an target language generating unit;

FIGS. 9A to 9C show examples of an ambiguous part detected by an ambiguous part detecting unit;

FIGS. 10A to 10C show examples of a result obtained by deleting the ambiguous part in the ambiguous part deleting unit;

FIG. 11 shows examples of the flow of the data processed by the communication support processing in the first embodiment;

FIG. 12 is an explanatory view showing examples of a translated-part display screen displayed by a translated-part presenting unit;

FIG. 13 is a block diagram showing a configuration of a communication support apparatus according to a second embodiment;

FIG. 14 is an explanatory view showing an example of a data structure of a concept hierarchy storing unit;

FIG. 15 is a flowchart showing the overall course of ambiguous part exclusion processing according to the second embodiment;

FIG. 16 is an explanatory view showing an example of an source language sentence output by an source language speech recognizing unit;

FIG. 17 is an explanatory view showing an example of an source language interpretation candidate output by an source language analyzing unit;

FIGS. 18A and 18B show examples of target language interpretation candidates output by a translation unit;

FIG. 19 shows examples of target language sentence candidates output by an target language generating unit;

FIG. 20 shows an example of an ambiguous part detected by an ambiguous part detecting unit;

FIG. 21 shows an example of a result obtained by replacing the ambiguous part by a superordinate concept in a concept replacing unit;

FIG. 22 shows an example of the flow of the data processed by the communication support processing in the second embodiment; and

FIG. 23 is an explanatory view showing an example of a translated-part display screen displayed by a translated-part presenting unit.

### DETAILED DESCRIPTION OF THE INVENTION

Exemplary embodiments of a communication support apparatus, a communication support method, and a computer program product according to this invention are described in detail below with reference to accompanying drawings.

A communication support apparatus according to a first embodiment interprets the semantic content of an source language sentence recognized from a speech, translates the interpreted semantic content in the source language into the semantic content in an target language, generates an target language sentence from the translated semantic content in the target language, and synthesizes and outputs a speech in the target language from the generated target language sentence. At this time, when a plurality of candidates are obtained in the processing results in speech recognition processing, source language analysis processing, translation processing and target language generation processing, a different between the respective candidates is detected and deleted as an ambiguous part to thereby eliminate the ambiguity of the target language sentence output finally.

Here, the source language sentence indicates a string expressed in an source language which is an source language to be translated, and the target language sentence indicates a string expressed in an target language which is a language to be translated into. Each of the source language sentence and the target language sentence is not limited to a sentence with a period, but sentences, a paragraph, a phrase, a word or the like may be applied.

Furthermore, while in the first embodiment, a communication support apparatus in which Japanese input by user's speech is translated into English and is output as a speech is explained as an example, the combination of the source language and the target language is not limited to this, but the present invention can be applied to any combination as long as an source language is translated into a different language.

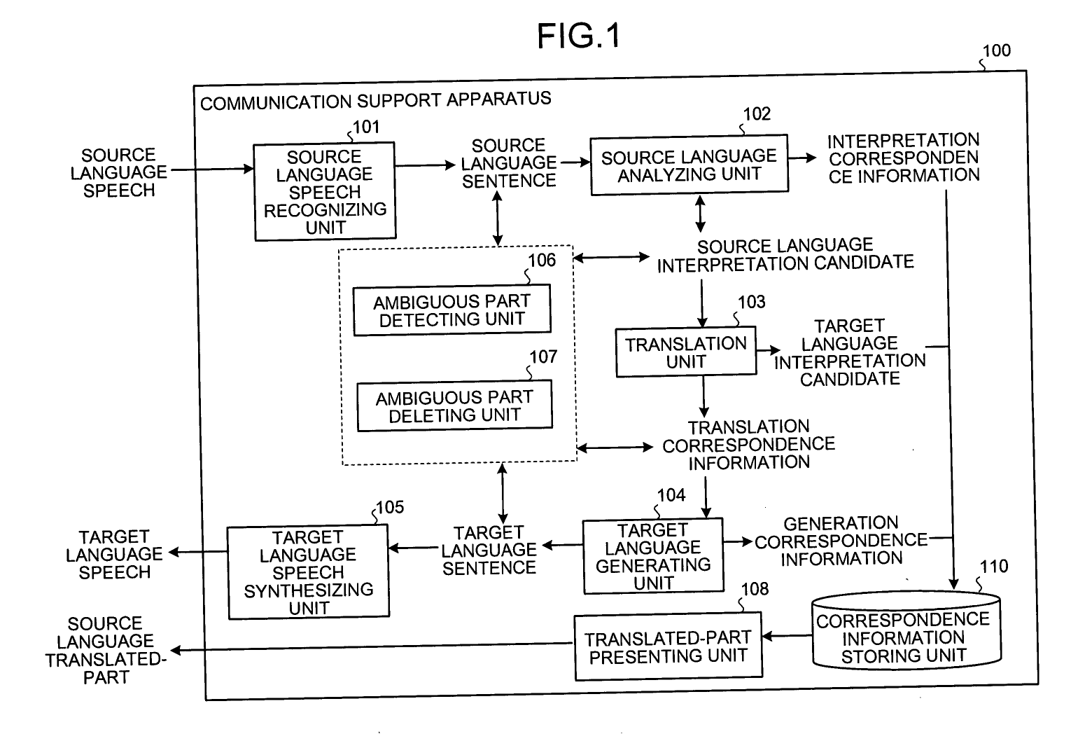

FIG. 1 is a block diagram showing a configuration of a communication support apparatus 100 according to a first embodiment. As shown in FIG. 1, the communication support apparatus 100 includes an source language speech recognizing unit 101, an source language analyzing unit 102, a translation unit 103, an target language generating unit 104, an objection language speech synthesizing unit 105, an ambiguous part detecting unit 106, an ambiguous part deleting unit 107, a translated-part presenting unit 108, and a correspondence information storing unit 110.

The source language speech recognizing unit 101 receives a speech in an source language which is uttered by a user, and performs speech recognition to thereby output an source language sentence candidate in which the speech content is transcribed. To the speech recognition processing performed by the source language speech recognizing unit 101 can be applied any commonly used speech recognition method using Linear Predictive Cording analysis, Hidden Markov Model (HMM), dynamic programming, a neural network, an n-gram language model or the like.

The source language analyzing unit 102 receives the source language sentence recognized by the source language speech recognizing unit 101, and performs natural language analysis processing such as morphological analysis, syntactic analysis, dependency parsing, semantic analysis and context analysis referring to vocabulary information and grammar rules of the source language to thereby output an source language interpretation candidate which is a candidate for interpretation of the semantic content indicated by the source language sentence. Further, the source language analyzing unit 102 outputs a correspondence relation between the source language sentence and the source language interpretation candidate as interpretation correspondence information.

The individual source language interpretation candidate obtained by the natural language analysis processing is a tree-structure graph which expresses a syntax structure and a dependency relation between concepts in the source language sentence, with the concepts corresponding to the source language vocabulary expressed as nodes. Accordingly, the interpretation correspondence information stores information in which a partial string included in the source language sentence is associated with a number for identifying each node (node identification number) in the tree-structure graph one-on-one.

To the natural language analysis processing performed by the source language analyzing unit 102 can be applied any commonly used method such as morphological analysis by the CYK method and syntactic analysis by Earley's method, Chart method, or generalized left to right (LR) parsing. Furthermore, a dictionary for natural language processing including the morphological information, syntax information, semantic information and the like is stored in a commonly used storage such as an HDD (Hard Disk Drive), an optical disk and a memory card, and is referred toxin the natural language analysis processing.

The translation unit 103 receives the source language interpretation candidate output by the source language analyzing unit 102 and outputs an target language interpretation candidate in reference to vocabulary information of the source language and the target language, structure conversion rules for absorbing structural differences between both languages, and a parallel translation dictionary indicating correspondence relations between the vocabularies of both languages. Furthermore, the translation unit 103 outputs a correspondence relation between the source language interpretation candidate and the target language interpretation candidate as translation correspondence information.

The target language interpretation candidate obtained by the translation processing is a candidate for an internal expression in English which is the target language. The target language interpretation candidate, similar to the source language interpretation candidate, is a tree-structure graph which expresses a syntax structure and a dependency relation between concepts of the target language sentence to be translated, with the concepts corresponding to the source language vocabulary expressed as nodes. Accordingly, the translation correspondence information stores information in which the node identification numbers of the tree-structure graph representing the source language interpretation candidate are associated with node identification numbers in the tree-structure graph representing the target language interpretation candidate one-on-one. To the translation processing by the translation unit 103 can be applied any method utilized in a general transfer method.

The target language generating unit 104 receives the target language interpretation candidate output by the translation unit 103 and outputs an target language sentence candidate in reference to the vocabulary information and grammar rules defining the syntax structure of English which is the target language and the like. Furthermore, the target language generating unit 104 outputs a correspondence relation between the target language interpretation candidate and the target language sentence candidate as generation correspondence information. The generation correspondence information stores information in which a node identification number of the tree-structure graph representing the target language interpretation candidate is associated with a partial string included in the target language sentence candidate one-on-one. To the target language generation processing performed here can be applied any commonly used language generation method.

The target language speech synthesizing unit 105 receives the target language sentence output by the target language generating unit 104 and outputs the content as a synthesized speech of English that is the target language. To the speech synthesis processing performed here can be applied any commonly used method such as a text-to-speech system speech using speech segment edition and speech synthesis, formant speech synthesis or the like.

When there exist a plurality of source language sentence candidates output by the source language speech recognizing unit 101, a plurality of source language interpretation candidates output by the source language analyzing unit 102, a plurality of target language interpretation candidates output by the translation unit 103, or a plurality of target language sentence candidates output by the target language generating unit 104, the ambiguous part detecting unit 106 detects and outputs a different part between the plurality of candidates as an ambiguous part.

The ambiguous part deleting unit 107 deletes the ambiguous part output by the ambiguous part detecting unit 106 from the source language sentence candidates or the source language interpretation candidates or the target language interpretation candidates or the target language sentence candidates. As a result, the plurality of candidates can be integrated into one candidate including no ambiguous part.

The translated-part presenting unit 108 identifies the partial string in the source language sentence corresponding to the target language sentence translated finally (hereinafter, translated part), by sequentially referring to the interpretation correspondence information output by the source language analyzing unit 102, the translation correspondence information output by the translation unit 103, and the generation correspondence information output by the target language generating unit 104, and screen display or the like is performed to thereby feed back to the user.

The correspondence information storing unit 110 is a storage that stores the interpretation correspondence information, the translation correspondence information, and the generation correspondence information, and can be composed of any commonly used storage such as an HDD, an optical disk and a memory card. The interpretation correspondence information, the translation correspondence information, and the generation correspondence information stored in the correspondence information storing unit 110 are referred to when the translated-part presenting unit 108 identifies the translated part.

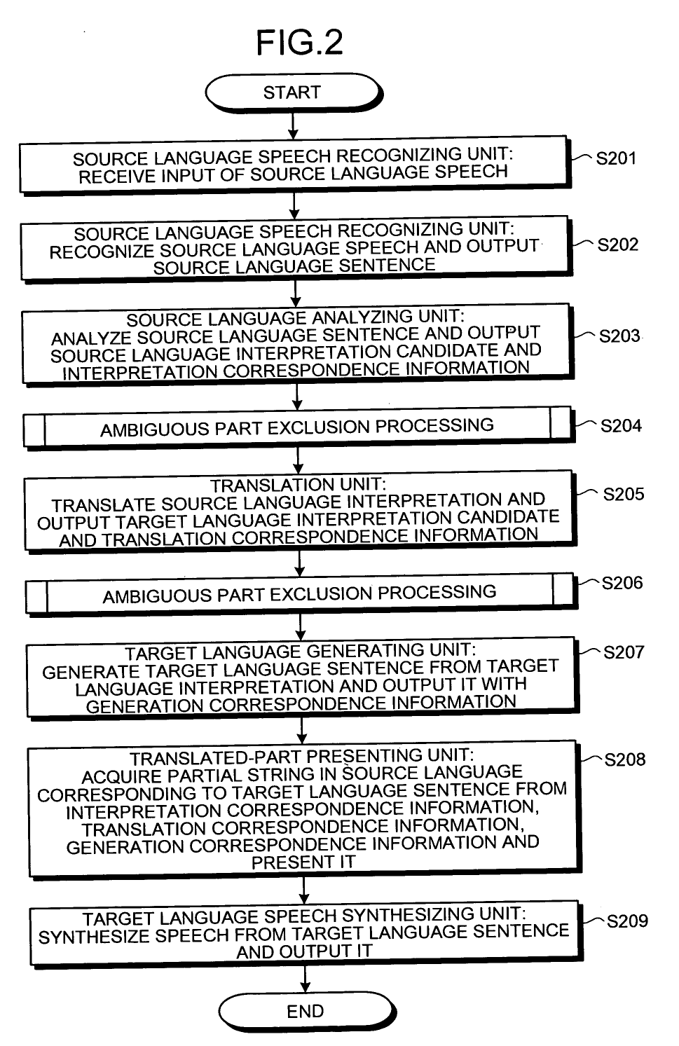

Next, the communication support processing by the communication support apparatus 100 according to the first embodiment configured as described above is explained. FIG. 2 is a flowchart showing the overall course of the communication support processing in the first embodiment.

The source language speech recognizing unit 101 first receives the input of a speech in the source language uttered by a user (step S201), performs the speech recognition processing for the received speech in the source language, and outputs an source language sentence (step S202).

Next, the source language analyzing unit 102 analyzes the source language sentence output by the source language speech recognizing unit 101, and outputs an source language interpretation candidate, and at the same time, outputs the interpretation correspondence information to the correspondence information storing unit 110 (step S203). More specifically, general natural language analysis processing such as morphological analysis, syntactic analysis, semantic analysis, and context analysis and the like is executed and an source language interpretation candidate with relations between the respective morphemes represented by a tree-structure graph is output.

Suppose, for example, a speech in Japanese which is pronounced as “ASUKURUMADEMATSU” and which, when translated into English, is interpreted in two ways of “I will wait until you come tomorrow” and “I will wait in the car tomorrow” is recognized, and as a result, a Japanese sentence 401 shown in FIG. 4 is input as an source language sentence. In this case, there are output two source language interpretation candidates: one is a candidate having three nodes 402, 403 and 404 as nodes of a tree-structure graph, and the other is a candidate having three nodes 405, 406, and 407 as nodes of a tree-structure graph. That is, in this case, there is shown an example in which by the morphological analysis, a Japanese language 408 which is a portion of the source language sentence is interpreted in two ways of a Japanese language 409 and a Japanese language 410 due to a difference in position of a comma punctuating the sentence and thus, the two source language interpretation candidates are output.

Here, each node is expressed in a format of “<concept label>@<node identification number>.” The concept label includes a label indicating an “object” or an “event” mainly corresponding to a noun such as, for example, “tomorrow” or “car,” a label indicating an “action” or a “phenomenon” mainly corresponding to a verb such as, for example, “wait” and “buy,” and a label indicating an “intention” or a “state” mainly corresponding to an auxiliary verb such as, for example, “ask,” “hope,” and “impracticable.” Furthermore, the node identification number is a number for uniquely identifying each node.

After the source language interpretation candidates are output at step S203, the ambiguous part exclusion processing is executed in which an ambiguous part is deleted from the plurality of source language interpretation candidates to output one source language interpretation candidate (step S204). Hereinafter, the detail of the ambiguous part exclusion processing is described.

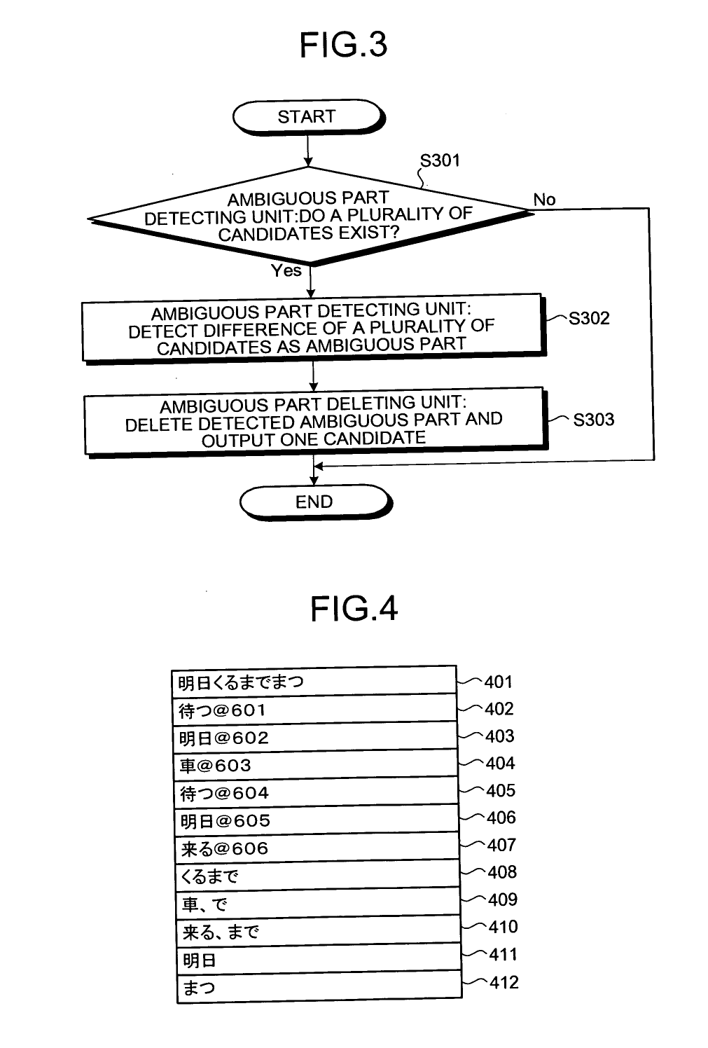

FIG. 3 is a flowchart showing the overall course of the ambiguous part exclusion processing. In the ambiguous part exclusion processing, the ambiguous part detecting unit 106 first determines whether or not there are a plurality of output candidates (step S301). When a plurality of candidates do not exist (step S301: No), no ambiguous part exists, so that the ambiguous part exclusion processing is finished.

When a plurality of candidates exist (step S301: Yes), the ambiguous part detecting unit 106 detects a difference between the plurality of candidates as an ambiguous part (step S302). For example, in the example (Japanese sentence 401), the Japanese language 408 is detected as the ambiguous part.

Next, the ambiguous part deleting unit 107 deletes the ambiguous part detected by the ambiguous part detecting unit 106 to thereby integrate the plurality of candidates into one candidate and output it (step S303), and the ambiguous part exclusion processing is finished. For example, in the example (the Japanese sentence 401), a candidate having a Japanese language 411 and a Japanese language 412 as two nodes of a tree-structure graph, with the Japanese language 408 deleted is output as the source language interpretation candidate.

After the ambiguous part exclusion processing for the source language interpretation candidate at step S204 is finished, the translation unit 103 translates the source language interpretation candidate with the ambiguous part excluded and outputs an target language interpretation candidate, and at the same time, outputs the translation correspondence information to the correspondence information storing unit 110 (step S205). For example, for the source language interpretation candidate having the Japanese 411 and the Japanese 412 as two nodes of the tree-structure graph, the target language interpretation candidate having “TOMORROW” and “WAIT” as two nodes of a tree-structure graph is output.

Next, the ambiguous part exclusion processing for the target language interpretation candidate is executed (step S206). Here, since only different point from the processing is that the ambiguous part exclusion processing is executed for the target language interpretation candidate instead of being executed for the source language interpretation candidate and the processing content is the same, the description thereof is not repeated. In the example, there exists no ambiguity in the target language interpretation candidate, so that the deletion processing of the ambiguous part is not executed and the ambiguous part exclusion processing is finished (Step S301: No).

After the ambiguous part exclusion processing for the target language interpretation candidate is executed (step S206), the target language generating unit 104 generates an target language sentence from the target language interpretation candidate, and at the same time, outputs the generation correspondence information to the correspondence information storing unit 110 (step S207). For example, an target language sentence “I will wait, tomorrow” is generated from the target language interpretation candidate having “TOMORROW” and “WAIT” as the two nodes of the tree-structure graph.

In this manner, in reference to knowledge of grammar and vocabulary of English which is the target language, the target language generating unit 104 arranges the style as English and complements a subject and the like which are omitted in the original Japanese text as the source language as necessary to thereby output an English surface text presenting the content of the target language interpretation candidate as the target language sentence.

Next, the translated-part presenting unit 108 acquires a translated part corresponding to the target language sentence generated by the target language generating unit 104 by sequentially referring to the interpretation correspondence information, the translation correspondence information, and the generation correspondence information which are stored in the correspondence information storing unit 110, and presents it to the user by screen display (step S208). It is intended to allow the user to easily understand which part of the partial strings included in the source language sentence has been translated and output as the target language sentence. The configuration in this manner allows the user to understand which part has been deleted by the translation, and to complement it in the conversation after that, etc. so that the support for the communication can be effectively executed. An example of the screen display for the presentation of the translated part (translated-part display screen) is described later.

Next, the target language speech synthesizing unit 105 synthesizes a speech in the target language from the target language sentence to output (step S209), and the communication support processing is finished. As a result of the screen display, when the user determines not to execute the speech output, the speech synthesis processing by the target language speech synthesizing unit 105 may not be performed, but the processing may return to the speech recognition processing to input again.

Furthermore, while the ambiguous part exclusion processing is executed only for the source language interpretation candidate and the objective language interpretation candidate, when a plurality of source language sentences which are the output results by the source language speech recognizing unit 101 exist and when a plurality of target language sentence candidates which are the output results by the target language generation unit 104 exist, a configuration in which the ambiguous part exclusion processing is executed in a manner similar to the foregoing may be employed. In this case, a configuration in which the ambiguous part exclusion processing is executed with the output results by the source language speech recognizing unit 101 expressed in lattice or the like may be employed. That is, the ambiguous part exclusion processing can be applied to any processing, as long as a plurality of processing results are output in a processing course and a different part between them can be detected as an ambiguous part.

Next, specific examples of the communication support processing in the communication support apparatus 100 according to the first embodiment are described.

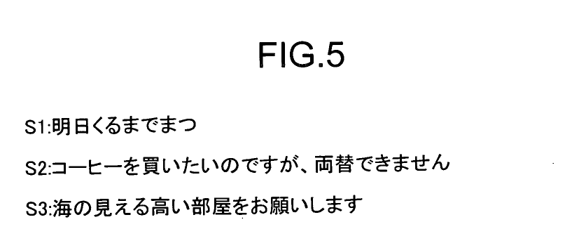

FIG. 5 shows examples of the source language sentence output by the source language speech recognizing unit 101. As shown in FIG. 5, three examples in which an source language sentence S1, an source language sentence S2, and an source language sentence S3 are input as the source language sentence, respectively are considered.

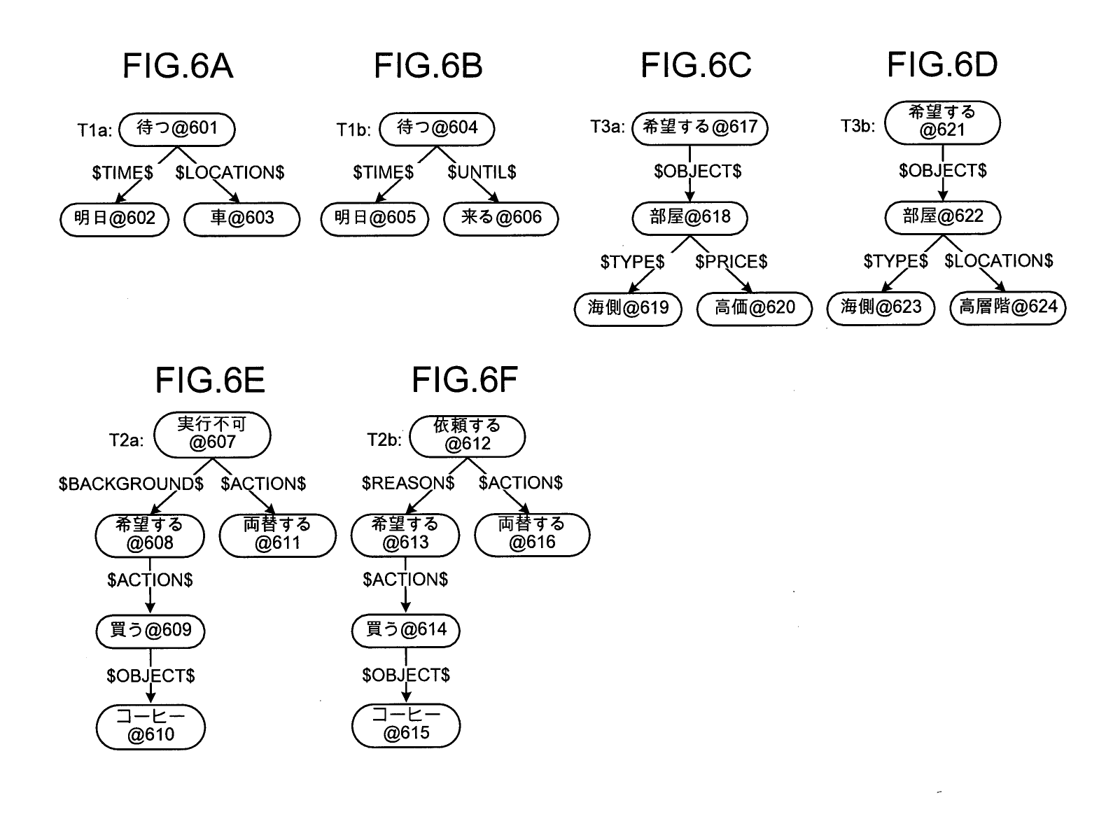

FIGS. 6A to 6F show examples of the source language interpretation candidates output by the source language analyzing unit 102. As shown in FIGS. 6A to 6F, the source language analyzing unit 102 outputs source language interpretation candidates T1a and T1b, T2a and T2b, T3a and T3b, corresponding to the source language sentences S1, S2, and S3, respectively.

The source language interpretation candidates are represented by tree-structure graphs as described above, and each node of the tree-structure graphs is represented in a format of <concept label>@<identification number>. Furthermore, an arc connecting the respective nodes of the tree-structure graph of the interpretation candidate indicates a semantic relation between the respective nodes, being represented in a format of “$<relation label>$.” The relation label includes semantic relations such as $TIME$ (time), $LOCATION$ (location), $UNTIL$ (temporally sequential relation), $BACKGROUND$ (background), $OBJECT$ (object), $ACTION$ (action), $REASON (reason), $TYPE$ (type) and the like, for example. The relation label is not limited to these, but any relation that indicates a semantic relation between the nodes can be included.

In FIGS. 6A to 6F, examples in each of which two source language candidates are output by the source language analyzing unit 102 are shown. The example of T1a and T1b is interpreted in two ways in morphological analysis.

The example of T2a and T2b is an example in which a plurality of interpretations arise in semantic analysis or context analysis which analyzes the semantic relation between the nodes and the speech intention.

The example of T3a and T3b is an example in which a plurality of interpretations arise in semantic analysis.

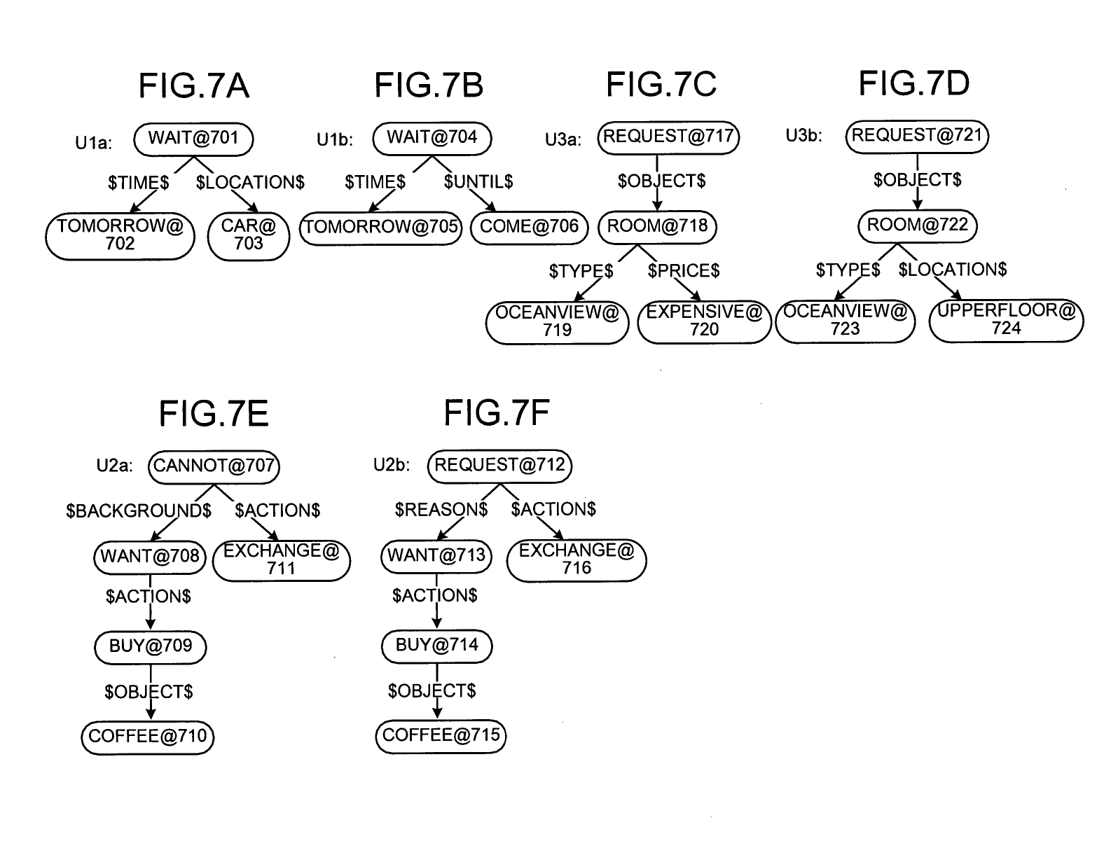

FIGS. 7A to 7F show examples of the target language interpretation candidates output by the translation unit 103. As shown in FIGS. 7A to 7F, the translation unit 103 outputs target language interpretation candidates U1a and U1b, U2a and U2b, U3a and U3b, corresponding to the source language interpretation candidates T1a and T1b, T2a and T2b, T3a and T3b.

Each of the target language interpretation candidates is a tree-structure graph, similar to the source language interpretation candidate, and each node indicates a concept in the target language, being represented in the form of “<concept label>@<node identification number>.” The notation and meaning of each arc of the target language interpretation candidate are similar to the notation and meaning of each arc in the source language interpretation candidate.

In the examples shown in FIGS. 7A to 7F, for example, U1a indicates that an action of “WAIT” is performed at the time of “TOMORROW” ($TIME$), at the place of “CAR” ($LOCATION$). On the other hand, U1b indicates that the action of “WAIT” is performed at the time of “TOMORROW” ($TIME$) until a phenomenon of “COME” occurs ($UNTIL$).

Furthermore, U2a indicates that there exists a background of “WANT” ($BACKGROUND$) to an action of “BUY” ($ACTION$) to an object of “COFFEE” ($OBJECT$), and that an action of “EXCHANGE” ($ACTION$) is in an impracticable state (CANNOT). On the other hand, U2b indicates having the intention of “REQUEST” to the action of “EXCHANGE” ($ACTION$) for the reason of “WANT” ($REASON$) to the action of “BUY” ($ACTION$) to the object of “COFFEE” ($OBJECT$).

Furthermore, U3a indicates having the intention of “REQUEST” to the object of “ROOM” as a target, whose price is “EXPENSIVE” ($PRICE$) and whose type is “OCEANVIEW” ($TYPE$). On the other hand, U3b indicates having the intention of “REQUEST” for the object of “ROOM” ($OBJECT$) as a target, whose location is “UPPERFLOOR” ($LOCATION$) and whose type is “OCEANVIEW” ($TYPE$).

The respective nodes of each of the target language interpretation candidates are translations of the concepts of the source language of the nodes corresponding to the relevant source language interpretation candidate into concepts of the target language. In the examples shown in FIGS. 7A to 7F, the structures of the tree-structure graphs of the source language interpretation candidates stay constant. While generally, the arc label or the structure of the graph which is a connection relation between the nodes may be changed by transfer processing or the like, the present invention can be applied to this case.

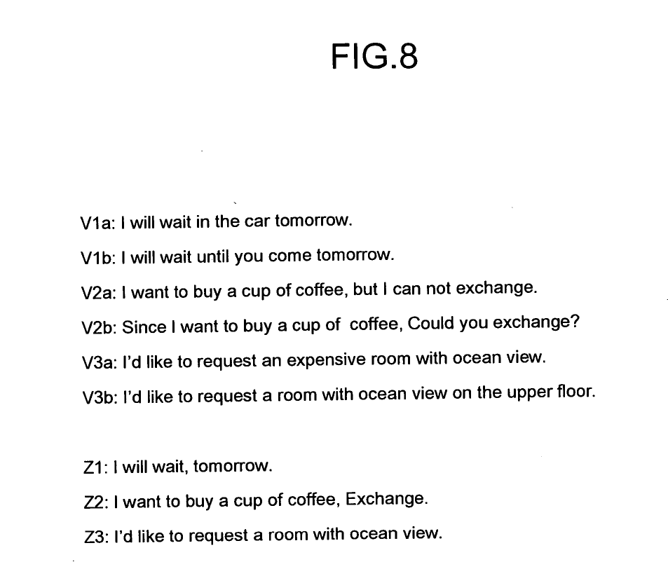

FIG. 8 show examples of the target language candidates output by the target language generating unit 104. As shown in FIG. 8, the target language generating unit 104 outputs target language sentence candidates V1a and V1b, V2a and V2b, V3a and V3b, corresponding to the target language interpretation candidates U1a and U1b, U2a and U2b, U3a and U3b, respectively. Furthermore, the target language sentence output finally with the ambiguous parts excluded are shown as Z1, Z2, and Z3.

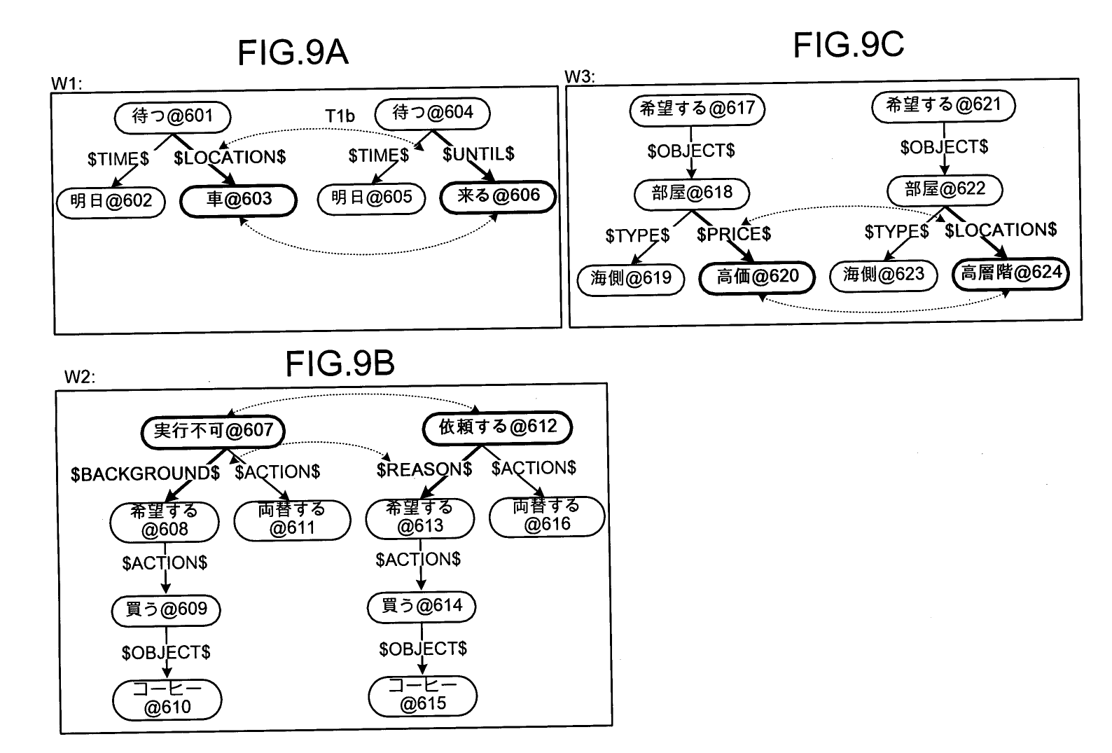

FIGS. 9A to 9C show examples of the ambiguous part detected by the ambiguous part detecting unit 106. In the examples shown in FIGS. 9A to 9C, results W1, W2, and W3 each obtained by detecting a different part between the respective two candidates as the ambiguous part in the ambiguous part detecting unit 106 are shown, corresponding to the source language interpretation candidates T1a and T1b, T2a and T2b, T3a and T3b in FIGS. 6A to 6F. In the figures, the ambiguous part is represented by heavy line and bold face and the correspondence relation of the ambiguous part between the two candidates is represented by arrow.

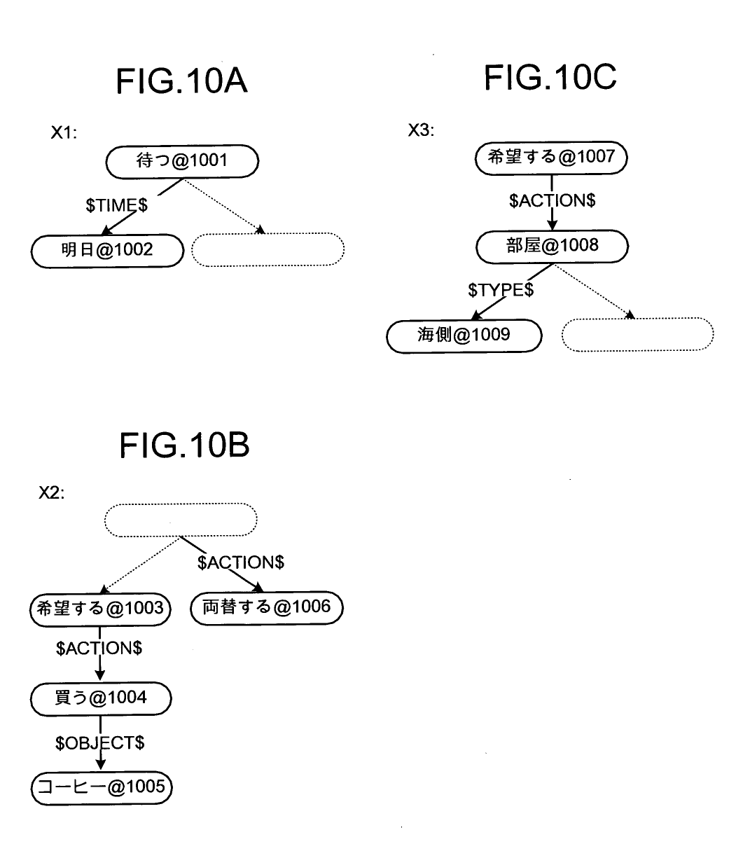

FIGS. 10A to 10C show examples of a result obtained by deleting the ambiguous part in the ambiguous part deleting unit 107. In the examples shown in FIGS. 10A to 10C, there are shown results X1, X2, and X3 obtained by deleting the respective ambiguous parts in the ambiguous part deleting unit 107, corresponding to the ambiguous part detection results W1, W2, and W3 of FIGS. 9A to 9C. The deleted ambiguous parts are indicated by dashed line.

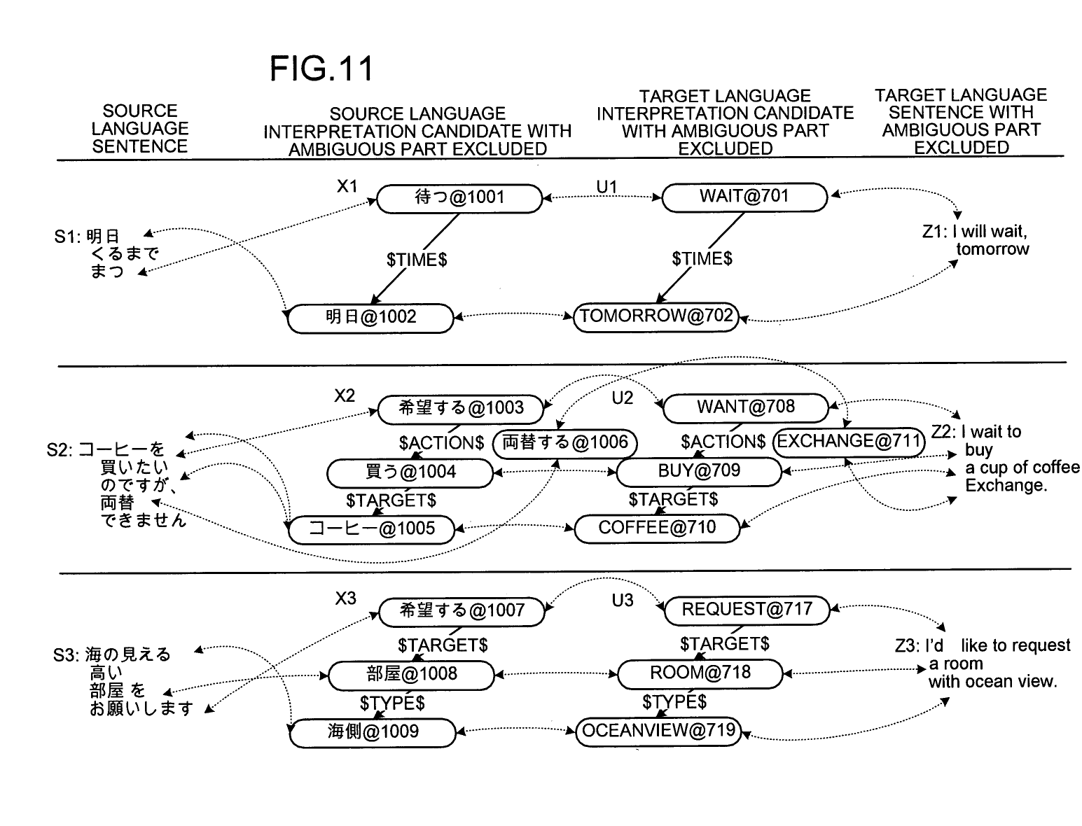

FIG. 11 shows examples of the flow of data processed by the communication support processing in the first embodiment. In FIG. 11, there is shown how each of the source language sentences input in the communication support processing obtains the source language interpretation candidate and the target language interpretation candidate and, is finally output as the target language sentence. Furthermore, the correspondence relation between the respective pieces of data is shown by arrow.

For example, when the source language sentence S1 is input, the source language interpretation candidates T1a and T1b are output by the source language analyzing unit 102, and through the detection of the ambiguous part by the ambiguous part detecting unit 106 and the deletion of the ambiguous part by the ambiguous part deleting unit 107, the source language interpretation candidate X1 with ambiguous part excluded is output.

Furthermore, the translation unit 103 executes the translation processing for the source language interpretation candidate X1 with the ambiguous part excluded, and outputs the target language interpretation candidate U1 with the ambiguous part excluded. Finally, the target language generating unit 104 executes the target language generation processing for the target language interpretation candidate U1 with the ambiguous part excluded, and outputs the target language sentence Z1 with the ambiguous part excluded.

Since the correspondence information storing unit 110 stores the correspondence information between the respective pieces of data as shown by arrow in FIG. 11, by following the correspondence relations from the target language sentence Z1 with the ambiguous part excluded, which is finally output, toward the source language sentence side, the translated-part presenting unit 108 can obtain the translated part corresponding to the target language sentence Z1 translated finally to display on screen.

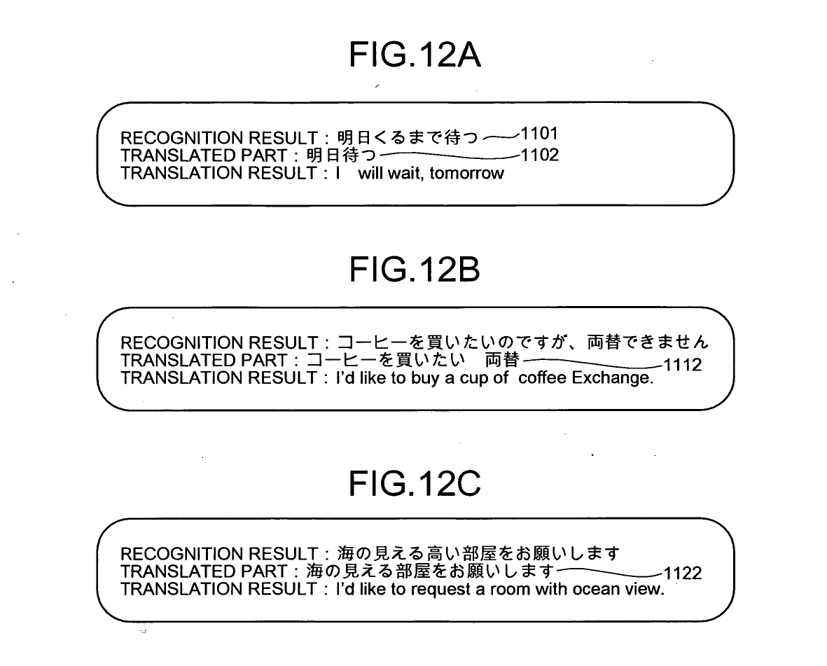

FIGS. 12A to 12C show examples of a translated-part display screen displayed by the translated-part presenting unit 108. As shown in FIGS. 12A to 12C, the translated-part display screen displays the source language sentence as a result of the speech recognition, the translated part and the target language sentence as a translation result in association with each other. Screen examples shown in FIGS. 12A to 12C are the screen examples when the examples of the source language sentences S1 to S3 in FIG. 5 are processed, respectively.

For example, the screen example in FIG. 12A shows that a Japanese sentence 1101 is output as a result of the speech recognition and the ambiguity exclusion processing and translation processing are executed, and consequently, the target language sentence “I will wait, tomorrow” is output. In this case, in the Japanese sentence 1101, since the Japanese language 408 of FIG. 4 is deleted as the ambiguous part, only the Japanese sentence 1102 is displayed on the screen as the translated part.

Similarly, in the screen example in FIG. 12B, only the Japanese sentence 1112 is displayed on the screen as the translated part. Furthermore, in the screen example in FIG. 12C, only the Japanese sentence 1122 is displayed on the screen as the translated part.

In this manner, the translated-part presenting unit 108 displays the translated part on the screen, which allows the user to confirm, in Japanese which is the source language, what translation result has finally been communicated to the other partner.

In the related art, for example, when it is ambiguous whether the price is high or the floor is high as shown in the screen example of FIG. 12C, either one is selected, and thus there is a possibility that a translation result of hoping for a high price room in spite of the face that a low price room is hoped for is communicated by error. However, according to the present invention, by deleting the ambiguous part and leaving only the part not including the ambiguous part, the possibility that a candidate not matching the intention of the user is selected by error is eliminated, and it becomes possible that at least a translation result including no error and matching the intention of the user is communicated to the other partner.

While in the fist embodiment, the commonly used transfer method composed of three courses of analysis of the source language sentence, the conversion (translation) into the target language and the generation of the target language sentence is described as a method for machine translation, the present invention can be applied to any method for machine translation such as example-based machine translation, statistics-based machine translation and interlanguage system machine translation, as long as ambiguity arises in the results output in the respective processing courses.

Furthermore, while in the first embodiment, the example in which the input of the source language sentence by the speech recognition and the output of the target language by the speech synthesis processing are executed is shown, a configuration in which the input of the source language sentence by pen-based input and the output of the target language by the screen display are executed may be employed. The input of the source language sentence and the output of the target language sentence are not limited to these, but any commonly used method can be applied.

As described above, in the communication support apparatus according to the first embodiment, when a plurality of processing result candidates are obtained in the speech recognition processing, the source language analysis processing, the translation processing, or the target language generation processing, by detecting and deleting a different part between the respective candidates as the ambiguous part, the ambiguity of the target language sentence output finally is deleted without the user's special operation, so that a proper target language sentence including no error can be obtained.

In a communication support apparatus according to a second embodiment, when a plurality of processing result candidates are obtained in the speech recognition processing, the source language analysis processing, the translation processing, or the target language generation processing, a different part between the respective candidates is detected as the ambiguous part and when there exists a superordinate concept of the semantic content of the ambiguous part, the ambiguous part is replaced by the superordinate concept to thereby exclude the ambiguity of the target language sentence output finally.

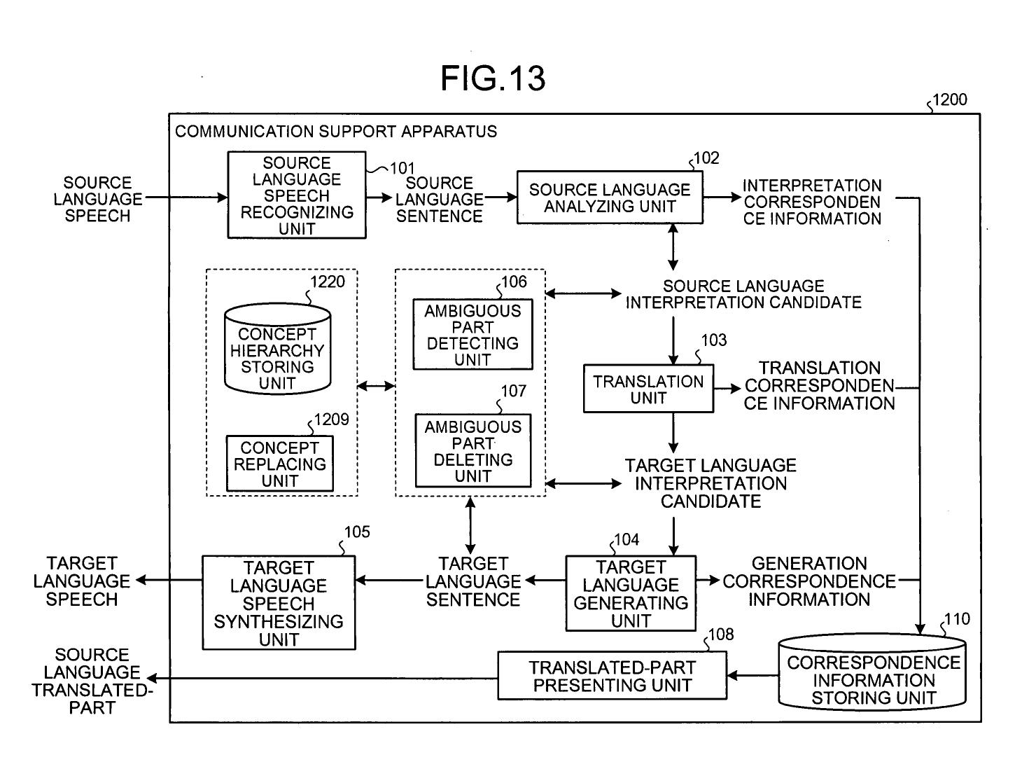

FIG. 13 is a block diagram showing a configuration of a communication support apparatus 1200 according to the second embodiment. As shown in FIG. 13, the communication support apparatus 1200 includes the source language speech recognizing unit 101, the source language analyzing unit 102, the translation unit 103, the target language generating unit 104, the objection language speech analyzing unit 105, the ambiguous part detecting unit 106, an ambiguous part deleting unit 107, the translated-part presenting unit 108, the correspondence information storing unit 110, a concept replacing unit 1209, and a concept hierarchy storing unit 1220.

In the second embodiment, the addition of the concept replacing unit 1209 and the concept hierarchy storing unit 1220 is different from the first embodiment. Since the other configurations and functions are similar to those of FIG. 1 which is a block diagram showing the configuration of the communication support apparatus 100 according to the first embodiment, the same reference number and signs are given and the description thereof is not repeated here.

The concept replacing unit 1209 retrieves a superordinate concept of the semantic content of an ambiguous part detected by the ambiguous part detecting unit 106 and when the superordinate concept can be retrieved, the ambiguous part is replaced by the retrieved superordinate concept.

The concept hierarchy storing unit 1220 is a storing unit in which a hierarchy relation between the concepts is stored in advance, and can be composed of any commonly used storage such as an HDD, an optical disk and a memory card. The concept hierarchy storing unit 1220 is utilized for searching for the superordinate concept of the semantic content indicated by the ambiguous part.

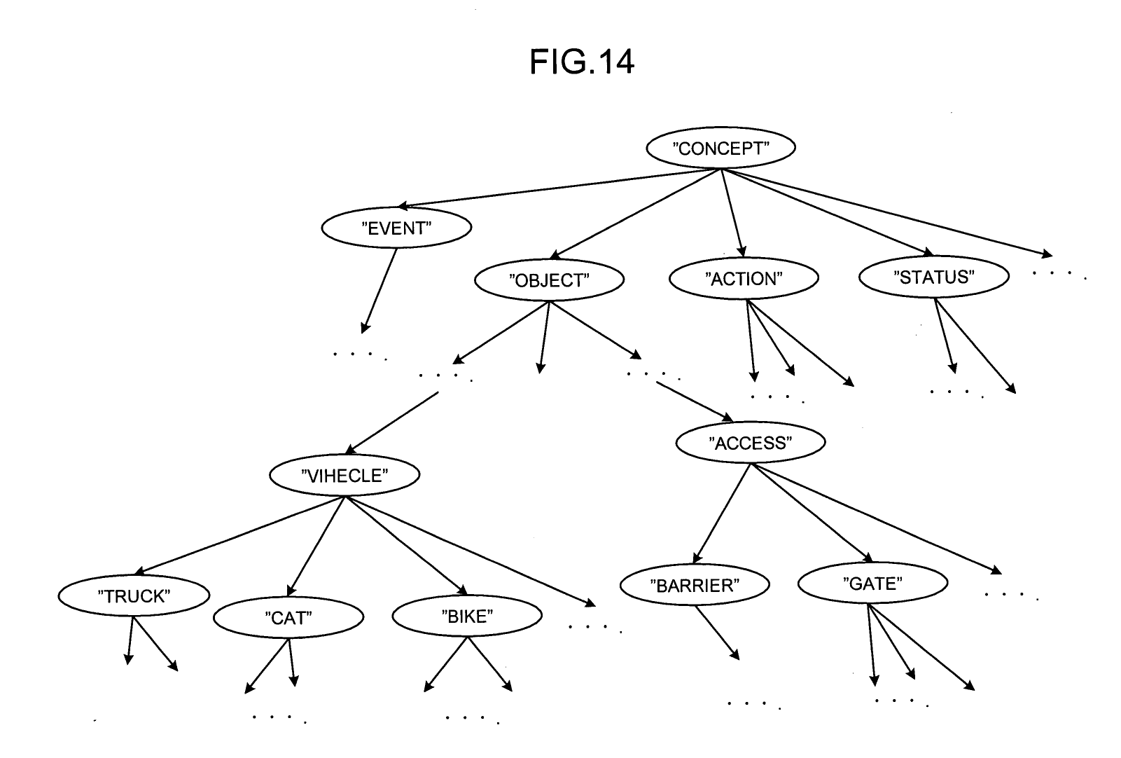

FIG. 14 is an explanatory view showing one example of a data structure of the concept hierarchy storing unit 1220. In FIG. 14, each word described inside of an ellipsoid represents a concept. Furthermore, the arrow shows that a concept located at a start point thereof is a superordinate concept of a concept located at an end point thereof. The sign “ . . . ” represents an omitted part.

For example, in FIG. 14, there is described knowledge that a concept “EVENT,” a concept “OBJECT,” and a concept “ACTION” are subordinate concepts of a concept “CONCEPT” which is a top superordinate concept, a concept “ACCESS” is a subordinate concept of the concept “OBJECT,” and a concept “GATE” and a concept “BARRIER” are subordinate concepts of the concept “ACCESS.”

Next, the communication support processing by the communication support apparatus 1200 configured as described above, according to the second embodiment is explained. In the second embodiment, although the detail of the ambiguous part exclusion processing is different from that of the first embodiment, the other processing is similar to that of the communication support processing shown in FIG. 2, and thus the description thereof is not repeated.

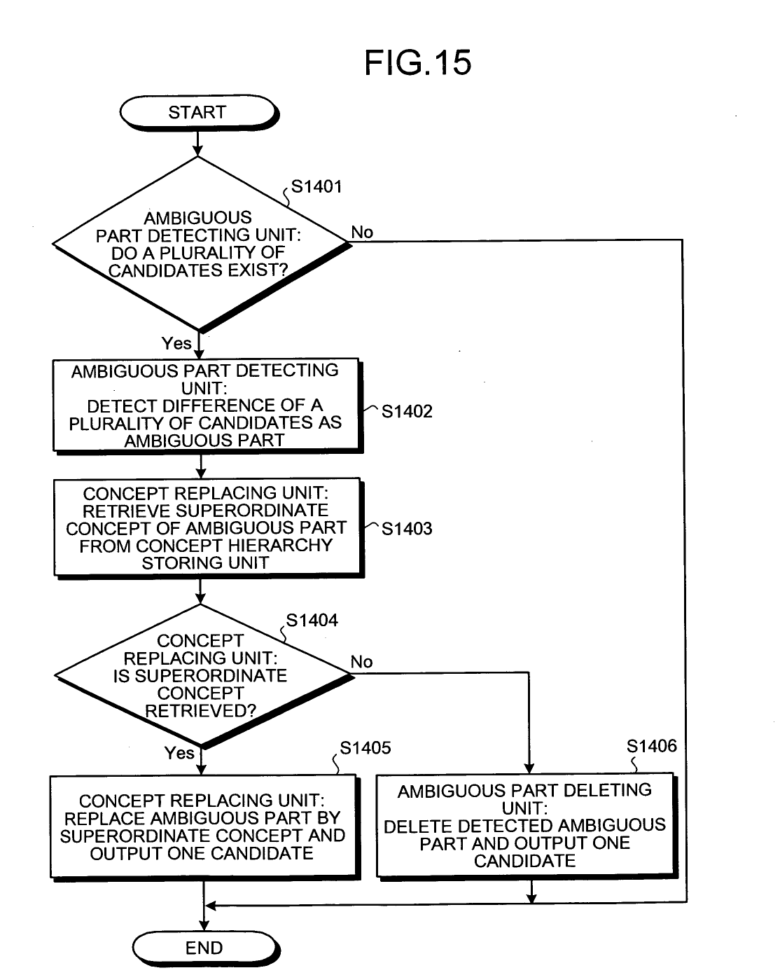

FIG. 15 is a flowchart showing the overall course of the ambiguous part exclusion processing in the second embodiment. Since the ambiguous part detecting processing from steps S1401 to S1402 is processing similar to that of step S301 to S302 in the communication support apparatus 100 according to the first embodiment, the description thereof is not repeated.

After the ambiguous part detecting unit 106 detects an ambiguous part (step S1402), the concept replacing unit 1209 retrieves a superordinate concept of the ambiguous part from the concept hierarchy storing unit 1220 (step S1403). More specifically, the concept replacing unit 1209 detects a superordinate concept in the lowest tier containing a plurality of concepts included in the ambiguous part, referring to the concept hierarchy storing unit 1220.

For example, on the premise of the data example of the concept hierarchy storing unit 1220 shown in FIG. 14, when the concept replacing unit 1209 retrieves a superordinate concept for an ambiguous part including a concept “TRUCK,” a concept “CAR,” and a concept “BIKE,” a concept “VIHECLE” is output by retrieving the concept in the lowest tier containing these. Furthermore, for example, when a superordinate concept is retrieved for an ambiguous part including the concept “BARRIER” and the concept “GATE,” the concept replacing unit 1209 outputs the concept “ACCESS,” and when a superordinate concept is retrieved for an ambiguous part including the concept “BARRIER” and the concept “VEHICLE,” the concept replacing unit 1209 outputs the concept “OBJECT.”

In order to avoid excessive abstraction, a configuration in which the limitation is imposed on the superordinate concept to be retrieved may be employed. For example, the configuration may be such that, when the number of arcs between the nodes representing the respective concepts is larger than the preset number, the superordinate concept is not retrieved. Furthermore, the configuration may be such that points are added according to a difference in hierarchy from the superordinate concept, and that when the points become larger than a preset value, the superordinate concept is not retrieved.

Next, the concept replacing unit 1209 determines whether or not the superordinate concept is retrieved (step S1404). When it is retrieved (step S1404: YES), the concept replacing unit 1209 replaces the ambiguous part by the retrieved superordinate concept to thereby integrate the plurality of candidates into one candidate (step S1405), and the ambiguous part exclusion processing is finished.

When the superordinate concept is not retrieved (step S1404: NO), the ambiguous part deleting unit 107 deletes the ambiguous part to thereby integrate the plurality of candidates into one candidate (step S1406) and the ambiguous part exclusion processing is finished.

In this manner, in the communication support apparatus 1200 according to the second embodiment, when the ambiguous part exists and when the superordinate concept of the ambiguous part exists, the ambiguous part can be replaced by the superordinate concept instead of simply deleting the ambiguous part. Therefore, the deletion of the ambiguous part can reduce the possibility that the intention of the user is not sufficiently communicated.

Next, specific examples of the communication support processing in the communication support apparatus 1200 according to the second embodiment are described.

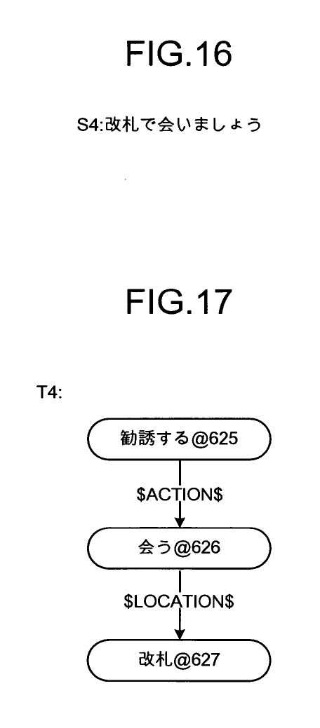

FIG. 16 is an explanatory view showing an example of the source language sentence output by the source language speech recognizing unit 101. As shown in FIG. 16, the example in which an source language sentence S4 is input as the source language sentence is considered.

FIG. 17 is an explanatory view showing an example of an source language interpretation candidate output by the source language analyzing unit 102. As shown in FIG. 17, the source language analyzing unit 102 outputs an source language interpretation candidate T4, corresponding to the source language sentence S4 in FIG. 16.

In the example shown in FIG. 17, only one source language interpretation candidate exists, that is, no ambiguous part exists.

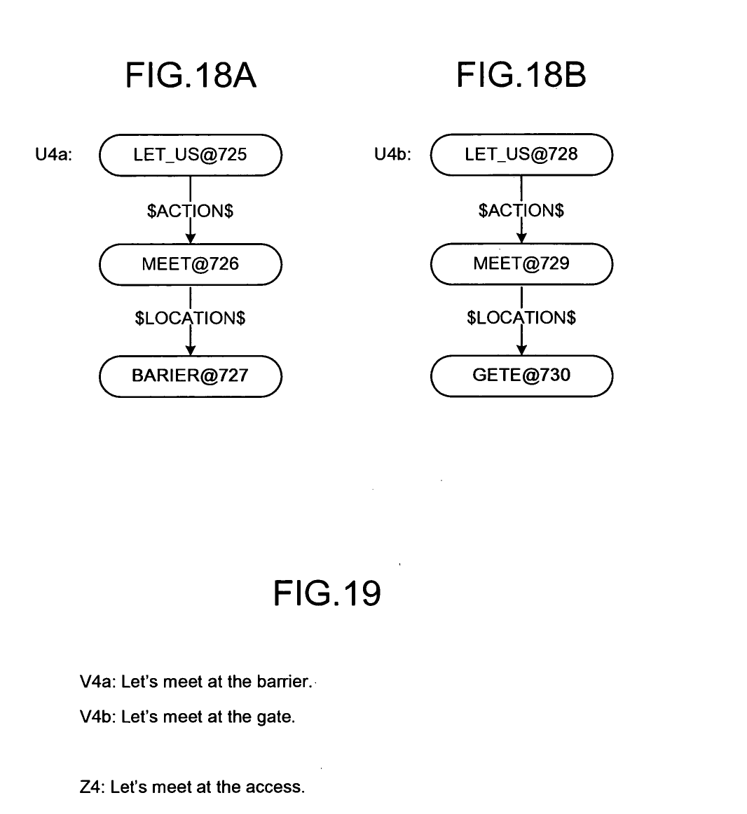

FIGS. 18A and 18B show examples of target language interpretation candidates output by the translation unit 103. As shown in FIGS. 18A and 18B, the translation unit 103 outputs target language interpretation candidates U4a and U4b, corresponding to the source language interpretation candidate T4 in FIG. 17.

In this example, the plurality of target language interpretation candidates U4a and U4b are output from the one source language interpretation candidate T4. This is because for the node to be identified with the node identification number 627 in T4, a plurality of nodes “BARRIER@727” and “GATE@730” are obtained as the translation candidates.

FIG. 19 shows examples of target language sentence candidates output by the target language generating unit 104. As shown in FIG. 19, the target language generating unit 104 outputs target language sentence candidates V4a and V4b, corresponding to the target language interpretation candidates U4a and U4b, respectively. Furthermore, the target language sentence output finally with the ambiguous part excluded is Z4.

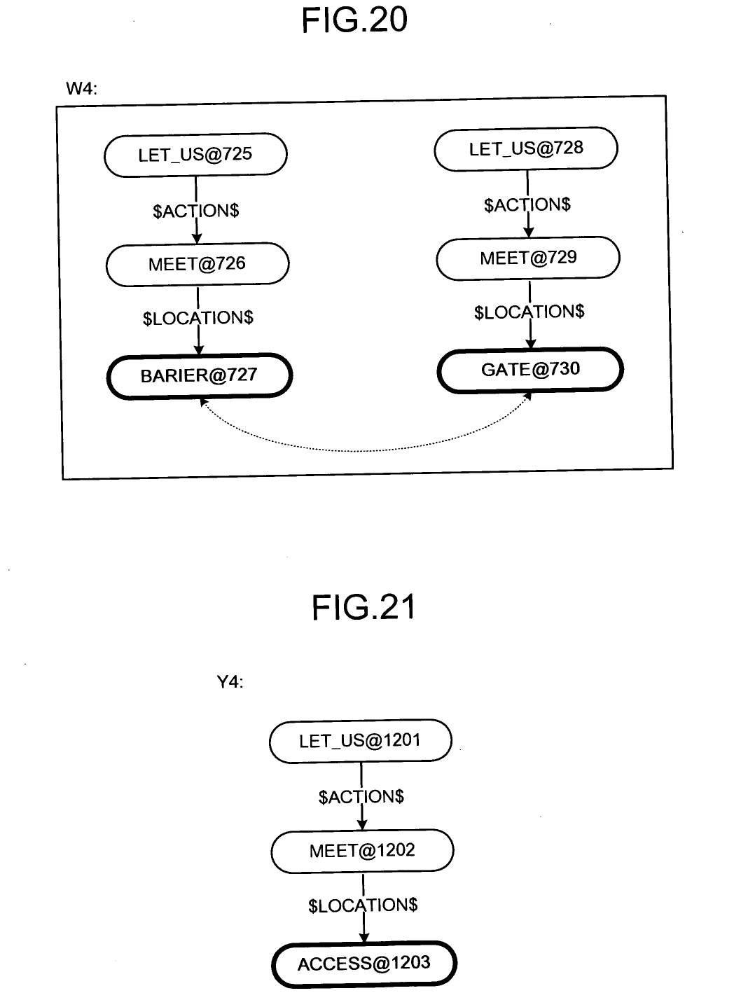

FIG. 20 shows the ambiguous part detected by the ambiguous part detecting unit 106. In the example illustrated in FIG. 20, there is shown a result W4 obtained by detecting a different part between the two target language interpretation candidates U4a and U4b in FIG. 18 as the ambiguous part, corresponding to the candidates, respectively, in the ambiguous part detecting unit 106.

FIG. 21 shows an example of a result obtained by replacing the ambiguous part by the superordinate concept in the concept replacing unit 1209. In the example shown in FIG. 21, there is shown a result Y4 obtained by replacing the ambiguous part by the superordinate concept “ACCESS@1203,” corresponding to the ambiguous part detection result W4 in FIG. 20, in the concept replacing unit 1209.

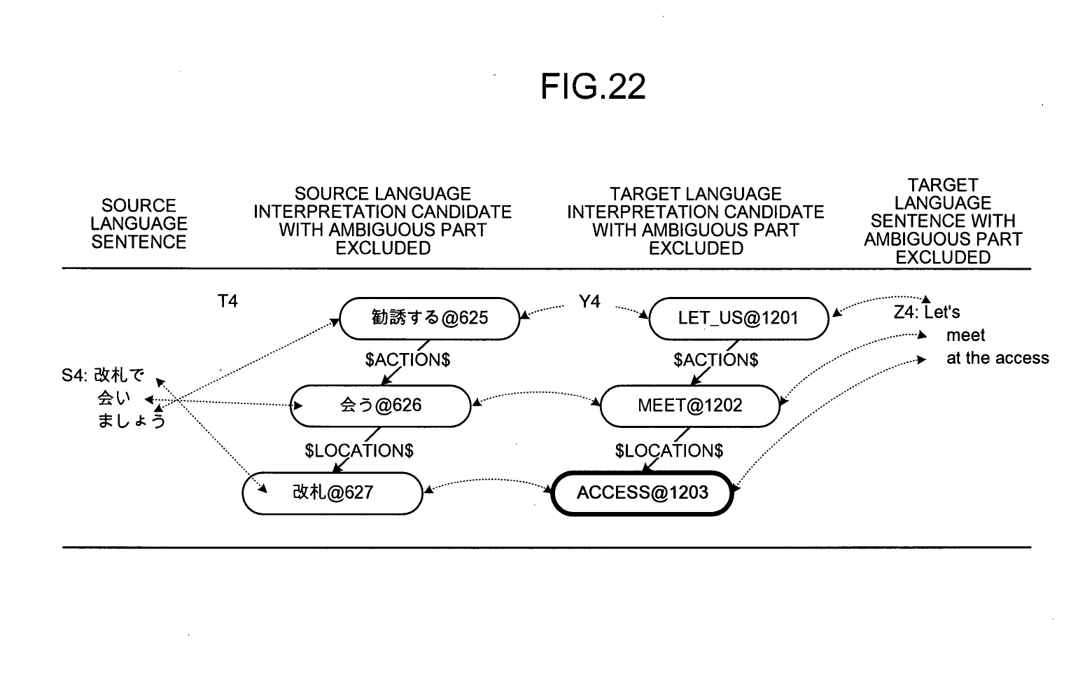

FIG. 22 shows an example of the flow of the data processed by the communication support processing in the second embodiment. In FIG. 22, there is shown how the original sentence input in the communication support processing obtains the source language interpretation candidate and the target language interpretation candidate, and is finally output as the target language sentence. Furthermore, the correspondence relation between the respective pieces of data is indicated by arrow.

For example, when the source language sentence S4 is input, the source language interpretation candidate T4 is output by the source language analyzing unit 102. In this example, since no ambiguity exists in the source language interpretation candidate, T4 corresponds to the source language interpretation candidate with the ambiguous part excluded.

Furthermore, the translation unit 103 executes the translation processing for the source language interpretation candidate T4 with the ambiguous part excluded, and outputs the target language interpretation candidates U4a and U4b. For these candidates, the detection of the ambiguous part by the ambiguous part detecting unit 106 and the replacement by the superordinate concept by the concept replacing unit 1209 are performed and the target language interpretation candidate Y4 with the ambiguous part excluded is output. Finally, the target language generating unit 104 executes the target language generation processing for the target language interpretation candidate Y4 with the ambiguous part excluded and outputs the target language sentence Z4 with the ambiguous part excluded.

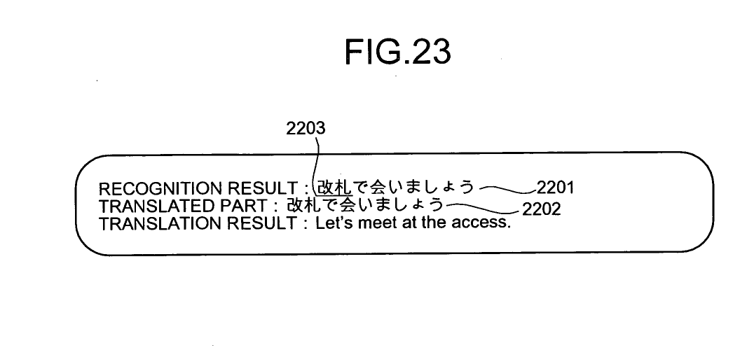

FIG. 23 shows an example of the translated-part display screen displayed by the translated-part presenting unit 108. As shown in FIG. 23, the example shows that as a result of the speech recognition, a Japanese sentence 2201 is output as the source language sentence and the ambiguous part exclusion processing and the translation processing are executed, and consequently, an target language sentence “Let's meet at the access” is output. In this case, although a Japanese word 2203 is detected as the ambiguous part, since the superordinate concept exists, the ambiguous part is not deleted but a Japanese sentence 2202 which is the same as the source language sentence is displayed on the screen as the translated part.

In this manner, in the second embodiment, since the ambiguous part can be replaced by the superordinate concept without deleting the ambiguous part, the translation result including no ambiguous part and matching the intention of the user can be communicated to the other partner.

As described above, the communication support apparatus according to the second embodiment, when a plurality of the processing result candidates are obtained in the speech recognition processing, the source language analysis processing, the translation processing or the target language generation processing, a different part between the respective candidates is detected as the ambiguous part and when a superordinate concept of the detected ambiguous part exists, the ambiguous part can be replaced by the superordinate concept. Furthermore, when no superordinate concept exists, the ambiguous part is deleted as in the first embodiment. This allows the ambiguity of the target language sentence output finally to be excluded, so that a proper target language sentence including no error can be obtained.

While in the first and second embodiments, using the communication devices utilizing the source language analysis, the language translation and the target language generation, the present invention is described, for example, pairs of the source language and the target language semantically equivalent to each other are stored in a storage (parallel translation pair storage) as parallel translation pairs, and when by selecting an target language sentence candidate from the parallel translation pairs, the communication support is realized, the technique of the present proposal can be applied.

A communication support program executed in the communication support apparatus according to the first or second embodiment is provided by being incorporated into a ROM (Read Only Memory) or the like in advance.

A configuration may be employed in which the communication support program executed in the communication support apparatus according to the first or second embodiment is provided by being recorded as a file in an installable format or executable format on a computer-readable recording medium such as a CD-ROM (Compact Disk Read Only Memory), a flexible disk (FD), a CD-R (Compact Disk Recordable), and a DVD (Digital Versatile Disk).

Furthermore, a configuration may be employed in which the communication support program executed in the communication support apparatus according to the first or second embodiment is provided by being stored on a computer connected to a network such as the Internet, and being downloaded via the network. Furthermore, a configuration may be employed in which the communication support program executed in the communication support apparatus according to the first or second embodiment is provided or delivered via a network such as the Internet.

The communication support program executed in the communication support apparatus according to the first or second embodiment has a module configuration including the units (the source language speech recognizing unit, the source language analyzing unit, the translation unit, the target language generating unit, the target language speech synthesizing unit, the ambiguous part detecting unit, the ambiguous part deleting unit, the translated-part presenting unit and the concept replacing unit), and as actual hardware, a CPU (Central Processing Unit) reads the communication support program from the ROM to execute, and thereby the units are loaded on a main storage and generated on the main storage.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication support apparatus comprising:
an analyzing unit that analyzes an source language sentence to be translated into a target language, and outputs at least one source language interpretation candidate which is a candidate for interpretation of the source language sentence;
a detecting unit that, when there are a plurality of the source language interpretation candidates, detects an ambiguous part which is a different part between the respective candidates in the plurality of source language interpretation candidates;
a translation unit that translates the source language interpretation candidate except the ambiguous part into the target language.

2. The communication support apparatus according to claim 1, further comprising:
a concept hierarchy storing unit that stores a hierarchy relation of a semantic content of a word;
a replacing unit that retrieves from the concept hierarchy storing unit a superordinate concept which is the semantic content in a superordinate tier common to semantic contents indicated by the ambiguous part of the respective candidates, and when the superordinate concept is retrieved, replaces the ambiguous part by the retrieved superordinate concept; and
a deleting unit that deletes the ambiguous part, when the replacing unit does not replace the ambiguous part by the superordinate concept.

3. The communication support apparatus according to claim 1, further comprising:
a generating unit that generates a target language sentence which is a sentence described in the target language, based on a target language interpretation candidate which is a candidate for the interpretation of a semantic content in the target language, and outputs at least one target language sentence candidate which is a candidate for the target language sentence,
wherein the analyzing unit outputs interpretation correspondence information which is information of correspondence between the source language sentence and the source language interpretation candidate,
the translation unit outputs translation correspondence information which is information of correspondence between the source language interpretation candidate and the target language interpretation candidate,
the generating unit outputs generation correspondence information which is information of correspondence between the target language interpretation candidate and the target language sentence candidate, and
a presenting unit that presents, in the source language, a string of a part corresponding to the target language sentence in the source language sentence, based on the interpretation correspondence information, the translation correspondence information and the generation correspondence information is further provided.

4. The communication support apparatus according to claim 3, further comprising a speech recognizing unit into which a speech in the source language is input and that recognizes the input speech and outputs at least one source language sentence candidate which is a sentence described in the source language,
wherein, when there are a plurality of the source language sentence candidates, the source language interpretation candidates, the target language interpretation candidates, or the target language sentence candidates, the detecting unit detects the ambiguous part which is a different part between the respective candidates in the plurality of source language sentence candidates, between the respective candidates in the plurality of source language interpretation candidates, or between the respective candidates in the plurality of target language interpretation candidates or between the respective candidates in the plurality of target language sentence candidates.

5. A communication support apparatus comprising:
an analyzing unit that analyzes of a source language sentence to be translated into a target language, and outputs at least one source language interpretation candidate which is a candidate for interpretation of the source language sentence;
a translation unit that translates the source language interpretation candidate into a target language, and outputs at least one target language interpretation candidate which is a candidate for the interpretation in the target language;
a detecting unit that, when there are a plurality of the target language interpretation candidates, detects an ambiguous part which is a different part between the respective candidates in the plurality of target language interpretation candidates; and
a generating unit that generates a target language sentence which is a sentence described in the target language, based on the target language interpretation candidate except the ambiguous part, and outputs at least one target language sentence candidate which is a candidate for the target language sentence.

6. The communication support apparatus according to claim 5, further comprising:
a concept hierarchy storing unit that stores a hierarchy relation of a semantic content of a word;
a replacing unit that retrieves from the concept hierarchy storing unit a superordinate concept which is the semantic content in a superordinate tier common to semantic contents indicated by the ambiguous part of the respective candidates, and when the superordinate concept is retrieved, replaces the ambiguous part by the retrieved superordinate concept; and
a deleting unit that deletes the ambiguous part, when the replacing unit does not replace the ambiguous part by the superordinate concept.

7. The communication support apparatus according to claim 5, wherein
the analyzing unit outputs interpretation correspondence information which is information of correspondence between the source language sentence and the source language interpretation candidate,
the translation unit outputs translation correspondence information which is information of correspondence between the source language interpretation candidate and the target language interpretation candidate,
the generating unit outputs generation correspondence information which is information of correspondence between the target language interpretation candidate and the target language sentence candidate, and
a presenting unit that presents, in the source language, a string of a part corresponding to the target language sentence in the source language sentence, based on the interpretation correspondence information, the translation correspondence information and the generation correspondence information is further provided.

8. The communication support apparatus according to claim 5, further comprising a speech recognizing unit into which a speech in the source language is input and that recognizes the input speech and outputs at least one source language sentence candidate which is a sentence described in the source language,
wherein, when there are a plurality of the source language sentence candidates, the source language interpretation candidates, the target language interpretation candidates, or the target language sentence candidates, the detecting unit detects the ambiguous part which is a different part between the respective candidates in the plurality of source language sentence candidates, between the respective candidates in the plurality of source language interpretation candidates, or between the respective candidates in the plurality of target language interpretation candidates or between the respective candidates in the plurality of target language sentence candidates.

9. A communication support apparatus comprising:
an analyzing unit that analyzes a source language sentence to be translated into a target language, and outputs at least one source language interpretation candidate which is a candidate for interpretation of the source language sentence;
a translation unit that translates the source language interpretation candidate into a target language, and outputs at least one target language interpretation candidate which is a candidate for the interpretation in the target language;
a generating unit that generates a target language sentence which is a sentence described in the target language, based on the target language interpretation candidate, and outputs at least one target language sentence candidate which is a candidate for the target language sentence;
a detecting unit that, when there are a plurality of the target language sentence candidates, detects an ambiguous part which is a different part between the respective candidates in the plurality of target language sentence candidates; and
a deleting unit that deletes the ambiguous part.

10. The communication support apparatus according to claim 9, further comprising:
a concept hierarchy storing unit that stores a hierarchy relation of a semantic content of a word; and
a replacing unit that retrieves from the concept hierarchy storing unit a superordinate concept which is the semantic content in a superordinate tier common to semantic contents indicated by the ambiguous part of the respective candidates, and when the superordinate concept is retrieved, replaces the ambiguous part by the retrieved superordinate concept,
wherein the deleting unit deletes the ambiguous part, when the replacing unit does not replace the ambiguous part by the superordinate concept.

11. The communication support apparatus according to claim 9, wherein
the analyzing unit outputs interpretation correspondence information which is information of correspondence between the source language sentence and the source language interpretation candidate,
the translation unit outputs translation correspondence information which is information of correspondence between the source language interpretation candidate and the target language interpretation candidate,
the generating unit outputs generation correspondence information which is information of correspondence between the target language interpretation candidate and the target language sentence candidate, and
a presenting unit that presents, in the source language, a string of a part corresponding to the target language sentence in the source language sentence, based on the interpretation correspondence information, the translation correspondence information and the generation correspondence information is further provided.

12. The communication support apparatus according to claim 9, further comprising a speech recognizing unit into which a speech in the source language is input and that recognizes the input speech and outputs at least one source language sentence candidate which is a sentence described in the source language,
wherein, when there are a plurality of the source language sentence candidates, the source language interpretation candidates, the target language interpretation candidates, or the target language sentence candidates, the detecting unit detects the ambiguous part which is a different part between the respective candidates in the plurality of source language sentence candidates, between the respective candidates in the plurality of source language interpretation candidates, or between the respective candidates in the plurality of target language interpretation candidates or between the respective candidates in the plurality of target language sentence candidates.

13. A communication support apparatus comprising:
an analyzing unit that analyzes a source language sentence to be translated into a target language, and outputs at least one source language interpretation candidate which is a candidate for interpretation of the source language sentence;
a detecting unit that, when there are a plurality of the source language interpretation candidates, detects an ambiguous part which is a different part between the respective candidates in the plurality of source language interpretation candidates;
a parallel translation pair storing unit that stores a parallel translation pair of the source language interpretation candidate and a target language sentence candidate semantically equivalent to each other; and
a selecting unit that selects the target language sentence candidate, based on the source language interpretation candidate except the ambiguous part and the parallel translation pair stored in the parallel translation storing unit.

14. The communication support apparatus according to claim 13, further comprising:
a concept hierarchy storing unit that stores a hierarchy relation of a semantic content of a word;
a replacing unit that retrieves from the concept hierarchy storing unit a superordinate concept which is the semantic content in a superordinate tier common to semantic contents indicated by the ambiguous part of the respective candidates, and when the superordinate concept is retrieved, replaces the ambiguous part by the retrieved superordinate concept; and
a deleting unit that deletes the ambiguous part, when the replacing unit does not replace the ambiguous part by the superordinate concept.

15. The communication support apparatus according to claim 13, wherein
the analyzing unit outputs interpretation correspondence information which is information of correspondence between the source language sentence and the source language interpretation candidate,
the translation unit outputs translation correspondence information which is information of correspondence between the source language interpretation candidate and the target language interpretation candidate,
the generating unit outputs generation correspondence information which is information of correspondence between the target language interpretation candidate and the target language sentence candidate, and
a presenting unit that presents, in the source language, a string of a part corresponding to the target language sentence in the source language sentence, based on the interpretation correspondence information, the translation correspondence information and the generation correspondence information is further provided.

16. The communication support apparatus according to claim 13, further comprising a speech recognizing unit into which a speech in the source language is input and that recognizes the input speech and outputs at least one source language sentence candidate which is a sentence described in the source language,
wherein, when there are a plurality of the source language sentence candidates, the source language interpretation candidates, the target language interpretation candidates, or the target language sentence candidates, the detecting unit detects the ambiguous part which is a different part between the respective candidates in the plurality of source language sentence candidates, between the respective candidates in the plurality of source language interpretation candidates, or between the respective candidates in the plurality of target language interpretation candidates or between the respective candidates in the plurality of target language sentence candidates.

17. A communication support method comprising:
analyzing the a source language sentence to be translated into a target language;
outputting at least one source language interpretation candidate which is a candidate for interpretation of the source language sentence;
when there are a plurality of the source language interpretation candidates, detecting an ambiguous part which is a different part between the respective candidates in the plurality of source language interpretation candidates;
translating the source language interpretation candidate except the ambiguous part into the target language.

18. A communication support method comprising:
analyzing the a source language sentence to be translated into a target language;
outputting at least one source language interpretation candidate which is a candidate for interpretation of the source language sentence;
translating the source language interpretation candidate into a target language;
outputting at least one target language interpretation candidate which is a candidate for the interpretation in the target language;
when there are a plurality of the target language interpretation candidates, detecting an ambiguous part which is a different part between the respective candidates in the plurality of target language interpretation candidates;
generating a target language sentence which is a sentence described in the target language, based on the target language interpretation candidate except the ambiguous part; and
outputting at least one target language sentence candidate which is a candidate for the target language sentence.

19. A communication support method comprising:
analyzing the a source language sentence to be translated into a target language;
outputting at least one source language interpretation candidate which is a candidate for interpretation of the source language sentence;
translating the source language interpretation candidate into a target language;
outputting at least one target language interpretation candidate which is a candidate for the interpretation in the target language;
generating a target language sentence which is a sentence described in the target language, based on the target language interpretation candidate;
outputting at least one target language sentence candidate which is a candidate for the target language sentence;
when there are a plurality of the target language sentence candidates, detecting an ambiguous part which is a different part between the respective candidates in the plurality of target language sentence candidates; and
deleting the ambiguous part.

20. A computer program product having a computer readable medium including programmed instructions for performing a communication support processing, wherein the instructions, when executed by a computer, cause the computer to perform:
analyzing the a source language sentence to be translated into a target language;
outputting at least one source language interpretation candidate which is a candidate for interpretation of the source language sentence;
when there are a plurality of the source language interpretation candidates, detecting an ambiguous part which is a different part between the respective candidates in the plurality of source language interpretation candidates;
translating the source language interpretation candidate except the ambiguous part into the target language.

21. A computer program product having a computer readable medium including programmed instructions for performing a communication support processing, wherein the instructions, when executed by a computer, cause the computer to perform:
analyzing the a source language sentence to be translated into a target language;
outputting at least one source language interpretation candidate which is a candidate for interpretation of the source language sentence;
translating the source language interpretation candidate into a target language;
outputting at least one target language interpretation candidate which is a candidate for the interpretation in the target language;
when there are a plurality of the target language interpretation candidates, detecting an ambiguous part which is a different part between the respective candidates in the plurality of target language interpretation candidates; and
generating a target language sentence which is a sentence described in the target language, based on the target language interpretation candidate except the ambiguous part; and
outputting at least one target language sentence candidate which is a candidate for the target language sentence.

22. A computer program product having a computer readable medium including programmed instructions for performing a communication support processing, wherein the instructions, when executed by a computer, cause the computer to perform:
analyzing the a source language sentence to be translated into a target language;
outputting at least one source language interpretation candidate which is a candidate for interpretation of the source language sentence;
translating the source language interpretation candidate into a target language;
outputting at least one target language interpretation candidate which is a candidate for the interpretation in the target language;
generating a target language sentence which is a sentence described in the target language, based on the target language interpretation candidate;
outputting at least one target language sentence candidate which is a candidate for the target language sentence;
when there are a plurality of the target language sentence candidates, detecting an ambiguous part which is a different part between the respective candidates in the plurality of target language sentence candidates; and
deleting the ambiguous part.
